(19) United States
(12) Patent Application Publication
(10) Pub. No.: US 2016/0267110 A1
(43) Pub. Date: Sep. 15, 2016

(54) SYSTEM AND METHOD FOR PROVIDING ACCESS TO DATA RECORDS

(71) Applicant: SIEMENS PRODUCT LIFECYCLE MANAGEMENT SOFTWARE INC., Plano, TX (US)

(72) Inventors: Kathleen deValk, Charlotte, NC (US); Amin Shah-Hosseini, Santa Clara, CA (US); Pengcheng Liu, Charlotte, NC (US); Kevin Farmer, Charlotte, NC (US); James Thomas, Indian Trail, NC (US)

(21) Appl. No.: 14/644,516

(22) Filed: Mar. 11, 2015

(51) Int. Cl. G06F 17/30; G06F 3/0482

(52) U.S. Cl. CPC G06F 17/30292; G06F 17/30557; G06F 3/0482

(57) ABSTRACT

A system is provided that enables access to data records associated with a product lifecycle management system. The system may include a metadata extractor component configured to determine metadata from data stored in data records and to store the metadata in a metadata library. Also, the system may include a schema configuration component configured to create a schema configuration based on metadata accessed from the metadata library. Further the system may include a schema builder component configured to generate a data store organized based on the created schema configuration, and to store data retrieved from the data records in the data store, based at least in part on metadata accessed from the metadata library based on the schema configuration. An application user interface that accesses the data store may dynamically change based on changes to the schema configuration and metadata library.

### TECHNICAL FIELD

The present disclosure is directed, in general, to computer-aided design, visualization, and manufacturing systems, product lifecycle management (“PLM”) systems, and similar systems, that manage data for products and other items (collectively, “Product Data Management” systems or PDM systems).

### BACKGROUND

PDM systems manage PLM and other data. PDM systems may benefit from improvements.

### SUMMARY

Variously disclosed embodiments include methods and systems for providing access to data records in a PDM environment. In one example, a system for providing access to data records may comprise a metadata extractor component operatively configured to cause at least one processor to determine metadata from data stored in the data records and to store the metadata in a metadata library. In addition, the system may include a schema configuration component operatively configured to cause at least one processor to create a schema configuration based at least in part on metadata accessed by the schema configuration component from the metadata library. Further, the system may include a schema builder component operatively configured to cause at least one processor to generate a data store organized based on the created schema configuration, and to store data retrieved from the data records in the data store, based at least in part on metadata accessed from the metadata library based on the schema configuration.

In another example, a method for providing access to data records comprises through operation of at least one processor, determining metadata from data stored in data records and storing the metadata in a metadata library. The method may also comprise through operation of at least one processor creating a schema configuration based at least in part on metadata accessed from the metadata library. Also the method may comprise through operation of at least one processor, generating a data store organized based on the created schema configuration and storing data retrieved from the data records in the data store, based at least in part on metadata accessed from the metadata library based on the schema configuration.

A further example may include, a non-transitory computer readable medium encoded with executable instructions (such as a software component on a storage device) that when executed, causes at least one processor to carry out this describe method.

The foregoing has outlined rather broadly the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the Detailed Description below, it may be advantageous to set forth definitions of certain words or phrases that may be used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

FIG. 1 illustrates a functional block diagram of an example system that facilitates providing access data records.

FIG. 2 illustrates example data structures that may be used by the system.

FIG. 3 illustrates an example graphical user interface that is usable to create a schema configuration based on metadata stored in a metadata library.

FIG. 4 illustrates an example graphical user interface for an application that is usable to view and analyze data stored in a generated data store based on metadata in the metadata library.

FIGS. 5 and 6 illustrate flow diagrams of example methodologies that facilitate providing access to data records.

FIG. 7 illustrates a block diagram of a data processing system in which an embodiment can be implemented.

### DETAILED DESCRIPTION

Various technologies that pertain to product data management and other data intensive applications will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system components may be performed by multiple components. Similarly, for instance, a component may be configured to perform functionality that is described as being carried out by multiple components. The numerous innovative teachings of the present application will be described with reference to exemplary non-limiting embodiments.

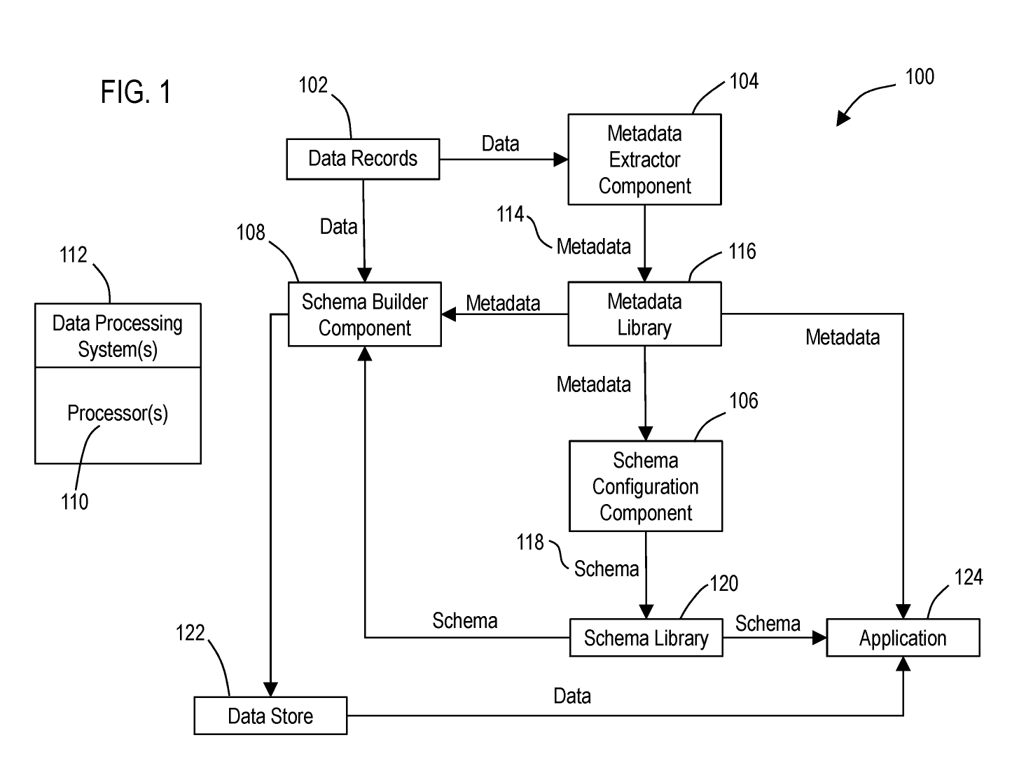

The examples described herein are directed to systems and methods that provide access to large amounts of data records. With reference to FIG. 1, an example system 100 that facilitates providing access to data records 102 is illustrated. The system 100 may include a metadata extractor component 104, a schema configuration component 106, and a dynamic schema builder component 108. Each of these components 104, 106, 108 may correspond to one or more software components and/or sub-components (e.g., programs, modules, applications, routines, functions) that are executed by one or more processors 110 (e.g., CPUs) in one or more data processing systems 112 (e.g., servers).

In FIG. 1, only one data processing system 112 is illustrated. However, it should be appreciated that the data processing system 112 may correspond to a distributed system in which each component may execute in a different physical data processing system (i.e., sever) connected via a network. Further in a virtual machine or network cloud environment, each data processing system may correspond to a virtual machine running in one or more physical data processing systems (servers).

The example system 100 is configured to work with large sets of data records 102 (e.g., with millions of records). In some example embodiments, such data records may correspond to event data records that represent manufacturing data for objects such as parts throughout the lifecycle of the part or associated product.

The data records 102 may be provided in a database and correspond to a primary record store that comprises data from a plurality of different source data sets. Data used to populate the data records 102 may originate from other databases, XML structures, and/or other data store structures. Also the process of providing data to generate the data records 102, may involve an extract/translate/load (ETL) process.

The system 100 is operative to extract metadata about the data sets from the data records, and leverage the metadata to define configurations for generating dynamic schemas that can be used by software systems to provide various functionalities for data access and analysis. This structure enables the system to provide such functionalities efficiently over very large data sets.

In example embodiments, the metadata extractor component 104 carries out extracting metadata from the data in the data records. The metadata is then used by the schema configuration component 106 (via a graphical user interface) that can create and adapt schemas as the needs of the users change, or as the data changes. This allows for dynamic schemas to be built for various purposes and consumed in applications through a contextualization layer.

Data records 102 for example may include product supply chain data used to handle data sets related to product quality information. In an example embodiment, the data records may be configured to represent events that occurs at some point in time, for some physical entities involved in the events (such as an instance of a product or sub-assembly within a product). Data collected during an event is extracted as attributes by the metadata extractor and stored as metadata 114 in a metadata library 116 for use in dynamic schemas and applications.

The data attributes are identified for use in populating the metadata library through inspection of the raw data stored in the data records 102. Schemas configurations for using the data in the data records may be defined by a user (using the schema configuration component 106) and may be consumed by the schema builder component 108. In an example embodiment, the schema builder component 108 is configured to create and populate data stores having schemas based on user defined schema configurations 118.

Example embodiments of the schema builder component may make use of massive parallel batch processing systems that allow for rapidly re-building of a data stores based on a new schema configuration. This makes the schemas both adaptive and dynamic without requiring applications to be re-written as the underlying structures change. In this way the framework employs a metadata-driven philosophy to the practical use case of structuring and consuming complex and rapidly changing data.

In an example embodiment, data used to populate the data records 102 (such as event data records) may be provided from an Omneo product available from Camstar, a Siemens business (Charlotte, N.C.).

It should be appreciated that event records may be associated with attributes which are commonly associated with most manufacturing, testing and repair events for a part, such as actor data (e.g., a person who performed an action associated with the event), location data (e.g., where the event took place), status data (e.g., pass fail designations for a test carried out on the part). In an example embodiment, some fields (e.g., attributes, properties) associated with the data records 102, may be dynamic (e.g., not fixed). In other words, such records may be associated with a variable number of additional attributes that are specified in data rather than via the schema structure of the database used to store the data records.

For example, events may be associated with a number of event attributes that vary over time and/or based on the sources of the data. For example, event data records associated with testing adhesives may include additional fields such as, curing time, ambient temperature and humidity. Whereas event data for testing electrical properties of a part may not include such fields, but include other attributes such as tested voltage ranges.

Also, different events for testing adhesives may have different additional fields. Such fields may vary because the data that is used to populate the described event records may come from many different types of PDM data bases, which capture different attributes used to compile the data for the data records 102.

Although, the described event data has the capability of storing variable data from many different PDM databases, it should be appreciated that the organization of the data and the variability of the data may make the described data records 102 conceptually difficult for an end user to directly analyze. Thus the example system 100 may be operative to provide a mechanism for organizing and manipulating such data records (e.g., data records with variable fields).

In an example embodiment, the metadata extractor is configured to cause a processor 110 of a data processing system 112 to determine metadata 114 from the data stored in data records 102 and to store the determined metadata 114 in a metadata library 116. To determine metadata, the metadata extractor processes the data in the data records associated 102 and determines various characteristics of the data which is referred to herein as metadata. The metadata library for example may correspond to one or more tables stored in a data store (e.g., a database). The data records 102 may be stored in one or more data stores (e.g., databases) accessible to the metadata component.

In the example system 100, the schema configuration component is configured to cause the processor 110 to create a schema configuration 118 based at least in part on metadata 114 accessed from the metadata library 116. Such a schema configuration for example may correspond to a list of columns for generating a table in a database along with associations to related metadata in the metadata library. Such a created schema configuration may be stored in a schema library 120. The schema library for example may correspond to one or more tables stored in a data store (e.g., a database). It should also be appreciated that the schema configuration component may be used by a user to create, update, and store a plurality of schema configurations in the schema library 120.

In addition, in an example system, the schema builder component 108 is configured to cause a processor 110 to generate a data store 122 organized based on the created schema configuration 118. In addition the schema builder component 108 is configured to store data records in a data store 122 (e.g., a database) with data retrieved from the data records 102, based at least in part on metadata 114 accessed from the metadata library 116. The data store 122 in this example may be available to one or more applications 124 that require use of at least some of the data stored in the data records 102. It should also be appreciated that the schema builder component may be used to create, update, and populate a plurality of data stores 122 in view of a plurality of schema configurations in the schema library 120.

Examples of applications that access the data stores 122 may include search engines, data warehouse applications, analytical tools and/or any other type of application that may need to access data stored in the data records 102. Such applications 124 for example may be configured to cause a processor 110 in a data processing system (e.g., a server), to provide a web site based graphical user interface through which users of a web browser may access the functionality provided by the application. However, it should be appreciated that such applications 122 may be distributed with a server side software application (executing on a server) that provides data from the data base 120 to a dedicated client side software application (executing on a client workstation, mobile phone, tablet, or other type of client side data processing system).

Example embodiments of applications configured in the manner described herein (e.g. configured to operate based on metadata and schema configurations) avoid having to be reengineered when the schema for its associated database changes. The described metadata library provides a method of avoiding this huge cost of change.

In example embodiments, the described schema configuration component 118 may be implemented as part of an application component 124 that consumes the data from one or more generated data stores. The schema can be modified through an application's schema configuration component directly and then the new schema can be exposed to the application by using information in the metadata library. However, it should be appreciated that in other embodiments the schema configuration component and the application component may correspond to different components used separately.

In example embodiments, the metadata extractor component 104 is operative to crawl through all the data in the data records 102 (which may include data acquired from different source data sets) and extracts metadata about the data itself. The metadata extractor component will crawl through each data record and extract the name and data type of all attributes that are associated with the record. The extracted name and data type of attributes may be stored in the metadata library as metadata fields and associated data types. In this way, the metadata extractor component builds the metadata library with metadata fields for identified attributes based on the actual data stored within data records. In addition, as will be explained in more detail below, the metadata extractor may extract statistics (i.e., metrics) such as the cardinality data for the values associated with each identified attribute, which are also stored in the metadata library.

In addition, as discussed previously, the full data set of data records 102 may contain data from multiple data sources. The metadata collected by the metadata extractor component identifies which attributes are related to which data sources. This way the metadata may identify: all attributes of data, the data type of each attribute, the data sources that contain the attribute, and the number of unique values found within the data for each attribute. As new attributes are added with new data, the metadata extractor component can be used to identify these new attributes and make them available in the metadata library.

Such new attributes can be from data records from new data sources or new attributes added to new records from existing data sources. For example, an “employee” data source may include an attribute “work phone”. If such a data source is altered to include a new attribute such as “cell phone”, the metadata extractor component will see the new attribute in the data records 102 (after the data records have been updated with data from the updated “employee” data source). The metadata extractor component will then create a new metadata field in the metadata library for the new attribute and will provide metadata statistics in the metadata library on that new attribute for all new data records that contain the new attribute. Extraction of metadata by the metadata extractor component may be configured as a fully automated process that can be scheduled to execute as data is added to the data records.

In example embodiments, the previously described schema configuration component is used to define schemas (i.e., data structures for tables) and mapping to the metadata to determine how the data structures are populated. This leverages the metadata collected by the metadata extractor. Any attribute found in the metadata library can be configured to be included in a schema. The schema configuration component may provide a graphical user interface to enable a user to define the schema configuration, which includes table structures and what data should be used to populate the data stores generated with such defined table structures.

The metadata driven user interface of the schema configuration component provides access to the source schema that was extracted automatically via the metadata extractor. The user specifies what attributes from the data records 102 should be included (via use of the metadata library) and can provide also some filtering to specify what data to be written into the data store 122 schema. The generation of the data store 122 and the transfer of data into the data store schema may be configured to be fully automated by the schema builder component.

In example embodiments, a schema configuration may include: a schema definition (such as column names for a table and data types for the columns) and a configuration mapping to the metadata fields in the metadata library that defines where the table column's source data comes from in the data records 102. A filtering mechanism may also be defined by the schema configuration component that can be used to include/exclude specific data from the data records when building the data stores 122. Partitioning and performance attributes may also be configured by the schema configuration component used to more efficiently store the data or distribute it over a massively parallel processing (MPP) data store architecture.

In example embodiments, the schema builder can consume the metadata associated with the schema configuration, retrieve the source data from the data records 102 and generate the data stores 122 according to the structure specified in the schema configuration in an efficient and repeatable fashion. It may also transform the retrieved data that is loaded into a data store. This is a repeatable process and can be executed on very large data sets (multiple billions of records) within hours depending on the hardware and databases the system is implemented with. This allows the system to achieve a quick turn-around to support the changing schemas that can be re-configured as customer needs change.

Example embodiments of the schema builder may be configured to support creation of a dynamic search schema data stores and multiple dynamic table schema data stores. It may also be configured to provide a translation that will take hierarchical data records and support the flattening of that data for easier consumption within applications while still maintaining the parent/child relationships. In example embodiments, destination storage engines for generated the data stores may include MPP systems for search (e.g., Apache Solr) and data warehouses (Cloudera Impala) due to their highly scalable nature. However, it should be appreciated that generated data stores may also be formed using other types of database tools (e.g., Microsoft SQL Server, Oracle).

The described system 100 provides a flexible approach to data storage and warehousing to support a myriad of software applications. Rather than providing rigid fixed schemas, example embodiments can be used to configure schemas as-needed and consume them through their configuration. The way in which data is stored will impact the speed at which the data can be accessed. So schemas may be defined in a format in which it can be most efficiently accessed to feed software applications.

As a user interacts with their data the nature of their questions may change, especially in the context of root cause analysis. This for example is applicable to tracking down product issues within the complex data structures inherent in supply chain quality systems. It often becomes even more complex when multiple independent data sources are needed in the data analysis. In this case the external data needs to be retrieved and mapped into a schema that can be consumed.

Using embodiments of the example systems describe herein, as the needs change, the schemas can be re-configured and the underlying data stores for applications can be re-processed repeatedly. Also, the client applications can be constructed to leverage the metadata-driven contextualization features of the system; thus, the applications do not need to change as the underlying schemas change. Rather an application may be managed to handle changing schemas through end user configuration of the application via the applications use of the metadata library and available schema configurations in the schema library. Thus, at runtime the application can automatically make available any new attributes when the schema is updated.

The example system may provide greater flexibility in the hands of the admin level user rather than requiring extensive expertise in programming and database design. This is because complexities are hidden by the example system from the user and are managed by the underlying frameworks. The admin user may merely work with a simple configuration UI and runtime selection controls of the application to accommodate working with data stores with variable schemas.

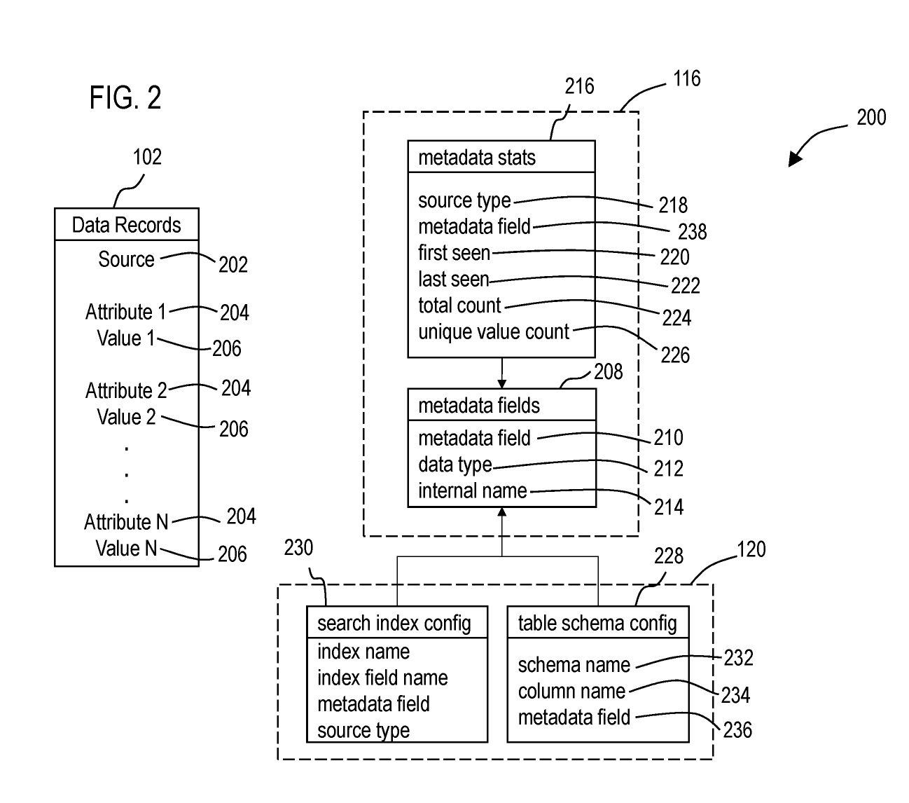

FIG. 2 illustrates a schematic view 200 of various databases/tables/libraries that may be used in an example system. Portions of the depicted tables may correspond to the metadata library 116 and the schema library 120. In this figure, data records 102 are depicted in a simplified form as having a reference to a parent data source 202 (which provided portions of the data now stored in the data records), as well as attributes 204 and corresponding data values 206 (from the parent data source). However, it should be appreciated that an actual implementation of the data records 102 may have a more complex structure. Further, the metadata library 116 and schema library 120 may have other forms and structures as well that are capable of carrying out the features described herein.

Also, as discussed previously, each data record 102 may be associated with a variable number of data record attributes and corresponding data values, that are different in type and number among the data records. For example one data record for an event associated with a part may have a first set of attributes and associated data values, while another data record for an event associated with a part may have a different number and or types of attributes and associated values.

The metadata extractor may be configured to evaluate the data stored in each data record to determine the attributes 204 associated with the data records. The metadata extractor may determine a list of metadata fields corresponding respectively to the determined data record attributes 204 and to store the determined list of metadata fields in the metadata library 116. In this example, the metadata fields determined from the data records may include each of the variable number of data record attributes found in the data records 102.

In this example, the metadata library 116 may include a metadata fields table 208 that is used to store a list of metadata fields 210. For each metadata field, the table may include a data type 212. The data type may be determined by the metadata extractor component from the type of data values 206 stored in association with the corresponding attribute 204 in the data records 102 that correspond to the metadata field 210 stored in the metadata fields table 208. In addition the metadata fields table 208 may include an internal name 214 for each metadata field.

As shown in FIG. 2, the metadata library may also include a metadata stats table 216 that provides additional data associated (via metadata field 238) with the metadata stored in the metadata fields table 208. The data stored in the metadata library may also include: source type data 218 (used to associate a metadata field with a reference to the source data set 202 of the data records 102); first seen data 220 (used to represent when the metadata extractor first found the associated attribute); a last seen data 222 (used to represent when the metadata extractor last found the associated attribute, when re-extracting metadata from the data records); a total count data 224 (used to represent the total count of data records containing the attribute); and a unique value count data 226 (used to represent the number of unique values for the attribute).

In example embodiments, the unique values data and the total count data are used to represent the cardinality of the attribute and are referred to herein as cardinality data. The metadata extractor component is operative to determine the total count data 224 and the unique value data 226 by counting and evaluating the uniqueness of data values stored for each attribute in the data records.

As shown in FIG. 2, the schema library 120 may include a table schema config table 228 and a search index config table 230. The table schema config table 228 may include data that defines schema configurations for table structures (that are built by the schema builder component 108). In an example embodiment, this table may include: schema name data 232 (used to store a name for a schema); column name data 234 (used to store a column name to be created in a database table for the schema); and metadata field data 236 (which specifies a metadata field from the metadata library 116 that is used to map attributes in the data records 102 to the table columns defined by the column name data 234).

The search index config table 230 may include data used to define search indexes that speed up queries from data stores generated for the corresponding schema configuration in the table schema config table 228.

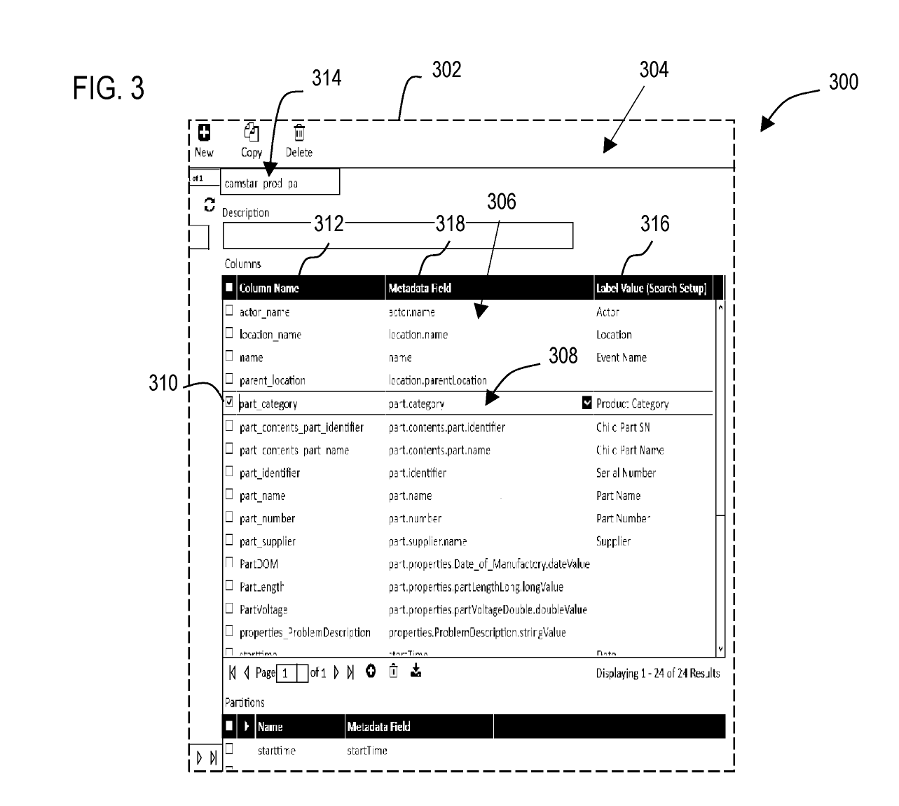

As discussed previously, the schema configuration component is operatively configured to provide a user interface usable to generate schema configurations based on the metadata from the metadata library. FIG. 3 illustrates an example view 300 of a portion of such a graphical user interface 302. Such a graphical user interface may include indicia 304 in the form of a window, web page, or other user interface that is usable to specify features of a schema.

In this described example, the schema configuration component may generate the graphical user interface so as to include a plurality of rows 306 for which a user can specify columns to create in a table and corresponding metadata so as to associate attributes from the data records with such columns. For example, a metadata field 308 may be selected via a dropdown user interface control that is populated from the list of metadata in the metadata library (under a metadata field column 318). Such metadata that is available to select may include the previously discussed metadata fields corresponding to attributes that may vary over time in the metadata library.

Each row may be associated with a check box 310, which when checked by a user (via an input device) specifies to include a corresponding column for the selected metadata field in a new schema configuration. Also, each row may also include a “Column Name” column 312 that provides a place to insert a user editable name for the column to be created in a table of a generated data store based on the new schema configuration. Further, each row may include a “Label Value” column 316 which allows a user to provide a user-friendly descriptive name for the column. In addition, the graphical user interface may provide a field to specify a name 314 of the schema configuration. It should also be noted that multiple schema configurations may be created and updated through this example user interface and stored in the schema library 120.

The schema configuration component may be operative to store the data provided via the graphical user interface in the table schema config table 228 of the schema library 120 as illustrated in FIG. 2. The schema configuration component may also be operative to determine and store corresponding indexes in the search index config table 230 of the schema library 120.

It should be noted that the schema configuration component may also be operative responsive to the sources type data 218 for metadata fields stored in the metadata library 116 to organize the listing of metadata in a manner that groups attributes from a common source. Further, embodiments of a graphical user interface may provide a hierarchical organization to the graphical user interface (such as a tree structure) in order to enable a user to drill down through different organized levels of metadata fields which may be related based on data source or other characteristics stored in the metadata library (such as cardinality).

In an example embodiment, the schema builder component 108 is operatively configured to generate a data store 122 so as to include the database table with columns having the column names specified in the schema configurations 118 stored in the schema library 120. In addition, the schema builder component is operative to populate the data store 122 with data values 128 for the attributes 126 from the data records 102 that correspond to the metadata fields 210 selected by the user in the schema configuration used to build the data store 122.

In an example embodiment, the metadata extractor component is operatively configured to update the metadata library with additions and deletions of metadata fields based on determined changes to the data in the data records. A metadata extractor component may be configured to have this occur automatically such as on a periodic and/or scheduled basis. However, it should be appreciated that the metadata extractor may also be manually executed to carry out these tasks.

The described schema configuration component 106 may be operatively configured to cause new instances of the graphical user interface to enable the user to update the schema configuration based on the changes to the metadata fields in the metadata library. Also, the schema builder component 108 may be configured to update (which may include replacing) the data store 122 based on detected changes to the schema configuration and the metadata library.

In example embodiments, the application 124 may be operatively configured to use the data in the data store 122 to output a graphical user interface having indicia based on the data stored in the data store. In addition such as application may be operative to dynamically change the output of the indicia based on changes to the schema configuration and metadata library.

For example, the application may use the metadata fields specified in the schema configuration to provide lists of fields usable to carry out searches and other functions with the data in the data store. Further the application may access metadata corresponding to the columns in the data store based on the metadata column name associations stored in the schema configuration. The application for example may use metadata statistics such as cardinality data and source data to organize the display and manipulation of data retrieved from the data store.

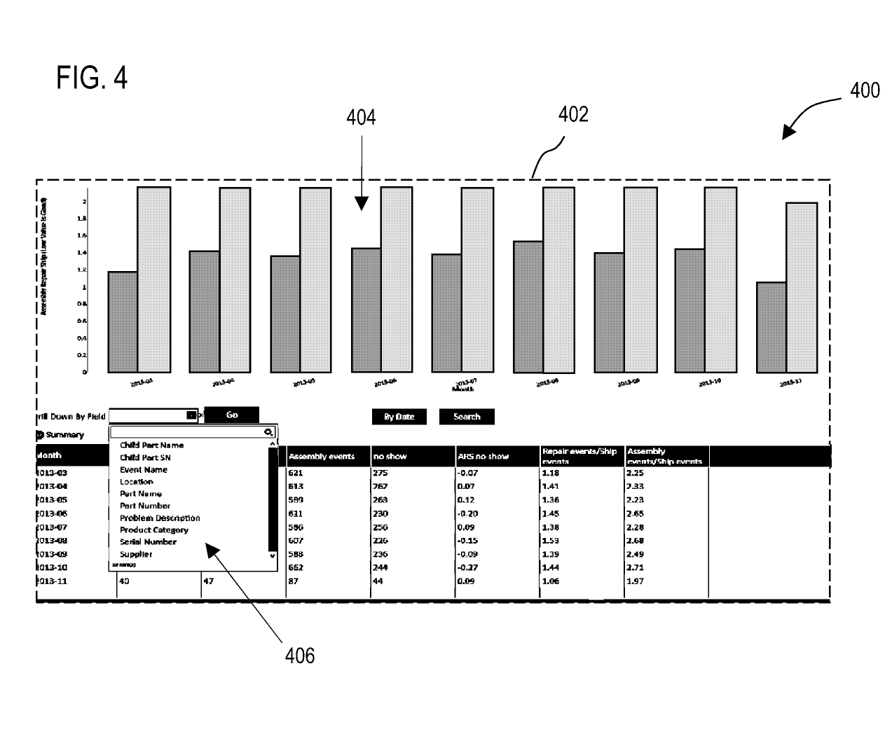

FIG. 4 illustrates an example view 400 of a portion of a graphical user interface 402 that comprises indicia 404 that displays data and selection fields usable to view and analyze data stored in one or more generated data stores 122.

In this example the graphical user interface may provide dynamic drop down options 406 for users to access and view data from a data store 122. In this example, the user is selecting a field to drill into from the list of fields available. This list of fields is determined by the metadata in the metadata library specified by the particular schema configurations associated with the data store 122. In an example embodiment, the metadata statistics (such as cardinality) in the metadata library may be used by the application to present relevant options for selecting and analyzing data from one or more data stores generated based on the schema configurations stored in the schema library 120. For example, cardinality can be used to recommend drill-down paths.

Example embodiments may leverage the use of metadata for analytics applications. For example, metadata may be leveraged when building queries in applications, especially when the query is executed across multiple data source types used to populate the data records.

In another example, a query builder application may use metadata from the metadata library to determine that a user-specified filter is for a metadata field/attribute that is only relevant to one data source set 202 in the data records (specified by the previously described source type data 218 in the metadata library). When querying data from multiple data source sets, the user-specified filter may only be applied to the data source set in which the field is relevant.

A graphical user interface for a query builder application may enable a user to drill down by a field that is only relevant to one of multiple data source sets within the analysis. Such a query builder application may check to see what data source set contains the drill-down field. If needed, the query builder application provides the correct processing logic to include the field in a subquery or join so that the field becomes available for the analysis.

Example embodiments may include other components as well, such as components to extract data from a data store 122 and store that data into a generic format (such as CSV file) so the data may be easily imported into a schema of an external data store. Also, performance may be enhanced by extracting data from data stores 122 in a relatively slow hard drive and placing them in data structures in RAM for consumption by applications. In addition, applications may provide graphical user interfaces that provide guided drill-down and data exploration based on metadata statistics (e.g. stored in the metadata stats table) collected in the metadata library.

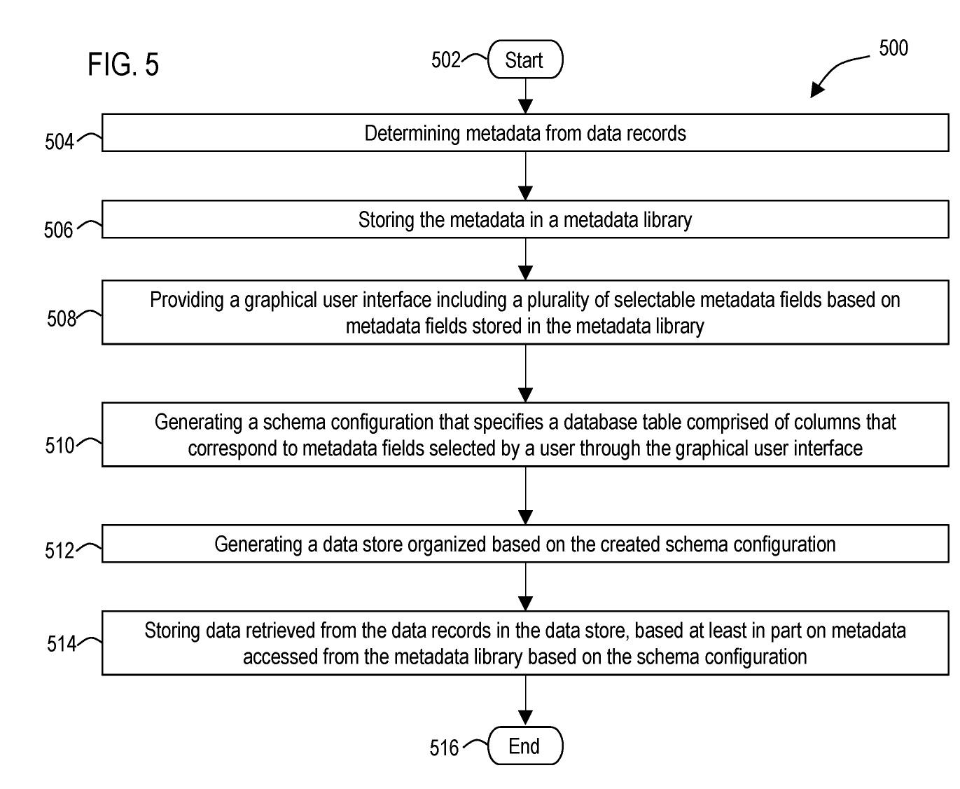

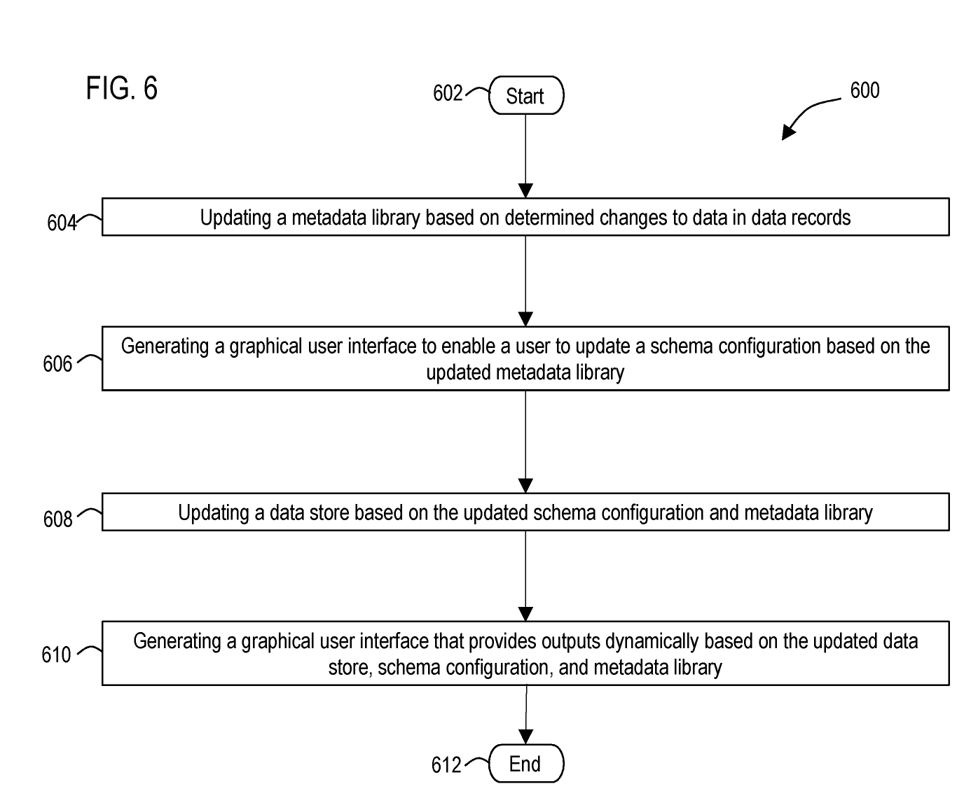

With reference now to FIGS. 5 and 6, various example methodologies are illustrated and described. While the methodologies are described as being a series of acts that are performed in a sequence, it is to be understood that the methodologies may not be limited by the order of the sequence. For instance, some acts may occur in a different order than what is described herein. In addition, an act may occur concurrently with another act. Furthermore, in some instances, not all acts may be required to implement a methodology described herein.

It is important to note that while the disclosure includes a description in the context of a fully functional system and/or a series of acts, those skilled in the art will appreciate that at least portions of the mechanism of the present disclosure and/or described acts are capable of being distributed in the form of computer-executable instructions contained within non-transitory machine-usable, computer-usable, or computer-readable medium in any of a variety of forms, and that the present disclosure applies equally regardless of the particular type of instruction or signal bearing medium or storage medium utilized to actually carry out the distribution. Examples of non-transitory machine usable/readable or computer usable/readable mediums include: ROMs, EPROMs, magnetic tape, floppy disks, hard disk drives, SSDs, flash memory, CDs, DVDs, and Blu-ray disks. The computer-executable instructions may include a routine, a sub-routine, programs, applications, modules, libraries, a thread of execution, and/or the like. Still further, results of acts of the methodologies may be stored in a computer-readable medium, displayed on a display device, and/or the like.

Referring now to FIG. 5, a methodology 500 that facilitates providing access to data records is illustrated. The methodology 500 begins at 502, and at 504 the methodology includes an act of determining metadata from data records. Also, at 506, the methodology includes the act of storing the metadata in a metadata library. In addition, at 508 the methodology includes the act of providing a graphical user interface including a plurality of selectable metadata fields based on metadata fields stored in the metadata library. Further, at 510, the methodology includes the act of generating a schema configuration that specifies a database table comprised of columns that correspond to metadata fields selected by a user through the graphical user interface. In addition at 512, the methodology includes the act of generating a data store organized based on the created schema configuration. Further at 514 the methodology includes the act of storing data retrieved from the data records in the data store, based at least in part on metadata accessed from the metadata library based on the schema configuration. At 516 the methodology may end.

Referring to FIG. 6, another methodology 600 that facilitates providing access to data records is illustrated. This methodology 600 begins at 602, and at 604 the methodology includes the act of updating a metadata library based on determined changes to data in data records. In addition, at 606, the methodology includes the act of generating a graphical user interface to enable a user to update a schema configuration based on the updated metadata library. Further, at 608 the methodology includes updating a data store based on the updated schema configuration and metadata library. In addition, at 610 the methodology includes the act of generating a graphical user interface that provides outputs dynamically based on the data stored in the updated data store, schema configuration, and metadata library. At 612 the methodology may end.

As discussed previously, such acts associated with these methodologies may be carried out by one or more processors. Such processor(s) may be included in one or more data processing systems for example that execute software components operative to cause these acts to be carried out by the one or more processors. In an example embodiment, such software components may be written in software environments/languages/frameworks such as Java, JavaScript, Python, .NET, C#, DHTML, or any other software tool capable of producing components and graphical user interfaces configured to carry out the acts and features described herein.

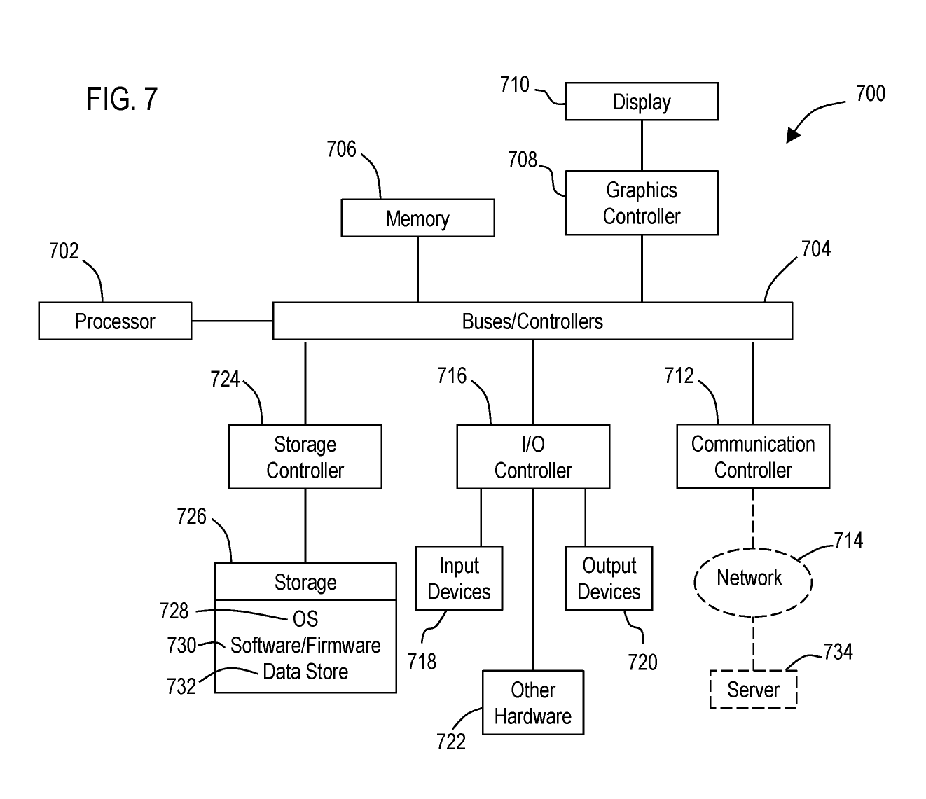

FIG. 7 illustrates a block diagram of a data processing system 700 (also referred to as a computer system) in which an embodiment can be implemented, for example as a portion of PDM system operatively configured by software or otherwise to perform the processes as described herein, and in particular as each one of a plurality of interconnected and communicating systems as described herein. The data processing system depicted includes at least one processor 702 (e.g., a CPU) that may be connected to one or more bridges/controllers/buses 704 (e.g., a north bridge, a south bridge). One of the buses 704 for example may include one or more I/O buses such as a PCI Express port bus. Also connected to various buses in the depicted example may include a main memory 706 (RAM) and a graphics controller 708. The graphics controller 708 may be connected to one or more displays 710. It should also be noted that in some embodiments one or more controllers (e.g., graphics, south bridge) may be integrated with the CPU (on the same chip or die). Examples of CPU architectures include IA-32, x86-64, and ARM processor architectures.

Other peripherals connected to one or more buses may include communication controllers 712 (Ethernet controllers, WiFi controllers, cellular controllers) operative to connect to a local area network (LAN), Wide Area Network (WAN), a cellular network, and/or other wired or wireless networks 714 or communication equipment.

Further components connected to various busses may include one or more I/O controllers 716 such as USB controllers, Bluetooth controllers, and/or dedicated audio controllers (connected to speakers and/or microphones). It should also be appreciated that various peripherals may be connected to the USB controller (via various USB ports) including input devices 718 (e.g., keyboard, mouse, touch screen, trackball, camera, microphone, scanners), output devices 720 (e.g., printers, speakers) or any other type of device that is operative to provide inputs or receive outputs from the data processing system. Further it should be appreciated that many devices referred to as input devices or output devices may both provide inputs and receive outputs of communications with the data processing system. Further it should be appreciated that other peripheral hardware 722 connected to the I/O controllers 716 may include any type of device, machine, or component that is configured to communicate with a data processing system.

Additional components connected to various busses may include one or more storage controllers 724. A storage controller may be connected to one or more storage drives, devices, and/or any associated removable media 726, which can be any suitable machine usable or machine readable storage medium. Examples, include nonvolatile devices, volatile devices, read only devices, writable devices, ROMs, EPROMs, magnetic tape storage, floppy disk drives, hard disk drives, solid-state drives (SSDs), flash memory, optical disk drives (CDs, DVDs, Blu-ray), and other known optical, electrical, or magnetic storage devices drives and media.

Also, a data processing system in accordance with an embodiment of the present disclosure may include an operating system 728, software/firmware 730, and data stores 732 (that may be stored on a storage device 726). Such an operation system may employ a command line interface (CLI) shell and/or a graphical user interface (GUI) shell. The GUI shell permits multiple display windows to be presented in the graphical user interface simultaneously, with each display window providing an interface to a different application or to a different instance of the same application. A cursor or pointer in the graphical user interface may be manipulated by a user through the pointing device. The position of the cursor/pointer may be changed and/or an event, such as clicking a mouse button, may be generated to actuate a desired response. Examples of operating systems that may be used in a data processing system may include Microsoft Windows, Linux, UNIX, iOS, and Android operating systems.

The communication controllers 712 may be connected to the network 714 (not a part of data processing system 700), which can be any public or private data processing system network or combination of networks, as known to those of skill in the art, including the Internet. Data processing system 700 can communicate over the network 714 with one or more other data processing systems such as a server 734 (also not part of the data processing system 700). However, an alternative data processing system may correspond to a plurality of data processing systems implemented as part of a distributed system in which processors associated with several data processing systems may be in communication by way of one or more network connections and may collectively perform tasks described as being performed by a single data processing system. Thus, it is to be understood that when referring to a data processing system, such a system may be implemented across several data processing systems organized in a disturbed system in communication with each other via a network.

In addition, it should be appreciated that data processing systems may be implemented as virtual machines in a virtual machine architecture or cloud environment. For example, the processor 702 and associated components may correspond to a virtual machine executing in a virtual machine environment of one or more servers. Examples of virtual machine architectures include VMware ESCi, Microsoft Hyper-V, Xen, and KVM.

Those of ordinary skill in the art will appreciate that the hardware depicted for the data processing system may vary for particular implementations. For example the data processing system 700 in this example may correspond to a computer, workstation, and/or a server. However, it should be appreciated that alternative embodiments of a data processing system may be configured with corresponding or alternative components such as in the form of a mobile phone, tablet, controller board or any other system that is operative to process data and carry out functionality and features described herein associated with the operation of a data processing system, computer, processor, and/or a controller discussed herein. The depicted example is provided for the purpose of explanation only and is not meant to imply architectural limitations with respect to the present disclosure.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Also, as used herein a processor corresponds to any electronic device that is configured via hardware circuits, software, and/or firmware to process data. For example, processors described herein may correspond to one or more (or a combination) of a CPU, FPGA, ASIC, or any other integrated circuit (IC) or other type of circuit that is capable of processing data in a data processing system, which may have the form of a controller board, computer, server, mobile phone, and/or any other type of electronic device.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 700 may conform to any of the various current implementations and practices known in the art.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element which must be included in the claim scope: the scope of patented subject matter is defined only by the allowed claims. Moreover, none of these claims are intended to invoke 35 USC §112(f) unless the exact words “means for” are followed by a participle.

What is claimed is:

1. A system for providing access to data records comprising:
a metadata extractor component operatively configured to cause at least one processor to determine metadata from data stored in data records and to store the metadata in a metadata library,
a schema configuration component operatively configured to cause at least one processor to create a schema configuration based at least in part on metadata accessed by the schema configuration component from the metadata library, and
a schema builder component operatively configured to cause at least one processor to generate a data store organized based on the created schema configuration, and to store data retrieved from the data records in the data store, based at least in part on the metadata accessed from the metadata library based on the schema configuration.

2. The system according to claim 1, wherein the data records include a plurality of attributes, wherein the metadata stored in the metadata library includes a listing of metadata fields corresponding respectively to the data record attributes determined by evaluating the data stored in each data record, wherein a plurality of the data records are associated with a variable number of data record attributes, that are different in type and number among said plurality of data records, wherein the metadata fields determined from the data records include each of the variable number of data record attributes.

3. The system according to claim 2, wherein the metadata that the metadata extractor component is operable to determine from the data records further includes cardinality data of at least one attribute found in the data records, which cardinality data is determined by the metadata extractor component counting the number of unique values stored in association with the at least one attribute.

4. The system according to claim 3, wherein the schema configuration component is operatively configured to cause at least one processor to provide a graphical user interface including a plurality of selectable metadata fields based on the listing of metadata fields stored in the metadata library, including the metadata fields corresponding to the variable number of attributes, wherein the schema configuration component is operatively configured to cause at least one processor to generate a schema configuration that specifies a data store table comprised of columns that correspond to metadata fields selected by a user through the graphical user interface.

5. The system according to claim 4, wherein the graphical user interface enables a user to provide column names for the columns of the data store table, wherein the schema configuration component is operatively configured to cause at least one processor to store the schema configuration in a schema library such that user provided column names for the data store table are stored in correlated relation with the metadata fields selected by the user.

6. The system according to claim 5, wherein the schema builder component is operatively configured to cause at least one processor to generate the data store so as to include the data store table with columns having the column names specified in the schema configuration, which columns are populated with data for the attributes from the data records that correspond to the metadata fields associated with the column names stored in the schema configuration.

7. The system according to claim 4, wherein, metadata extractor component is operatively configured to update the metadata library with additions and deletions of metadata fields based on determined changes to the data in the data records.

8. The system according to claim 7, wherein the schema configuration component is operatively configured to cause at least one processor to have the graphical user interface enable the user to update the schema configuration based on the changes to the metadata fields in the metadata library.

9. The system according to claim 8, wherein the schema builder component is operatively configured to cause at least one processor to update the data store based on changes to the schema configuration and the metadata library.

10. The system according to claim 9, further comprising an application that is operatively configured to cause at least one processor to generate a further user interface that outputs indicia based on the data stored in the data store, wherein the application is operative to dynamically change the output of the indicia based on changes to the schema configuration and metadata library.

11. A method for providing access to data records comprising:
through operation of at least one processor, determining metadata from data stored in data records and storing the metadata in a metadata library,
through operation of at least one processor creating a schema configuration based at least in part on metadata accessed from the metadata library, and
through operation of at least one processor, generating a data store organized based on the created schema configuration and storing data retrieved from the data records in the data store, based at least in part on metadata accessed from the metadata library based on the schema configuration.

12. The method according to claim 11, wherein the data records include a plurality of attributes, further comprising evaluating the data stored in each data record to determine metadata fields corresponding respectively to the data record attributes and storing a listing of metadata fields in the metadata library, wherein a plurality of the data records are associated with a variable number of data record attributes, that are different in type and number among said plurality of data records, wherein the metadata fields determined from the data records include each of the variable number of data record attributes.

13. The method according to claim 12, further comprising evaluating the data stored the data records to determine cardinality data of at least one attribute found in the data records and storing the cardinality data in the metadata library, which cardinality data is determined by counting the number of unique values stored in association with the at least one attribute.

14. The method according to claim 13, providing a graphical user interface including a plurality of selectable metadata fields based on the listing of metadata fields stored in the metadata library, including the metadata fields corresponding to the variable number of attributes, and generating a schema configuration that specifies a data store table comprised of columns that correspond to metadata fields selected by a user through the graphical user interface.

15. The method according to claim 14, wherein the graphical user interface enables a user to provide column names for the columns of the data store table, further comprising storing the schema configuration in a schema library such that column names provided by the user for the data store table are stored in correlated relation with the metadata fields selected by the user.

16. The method according to claim 15, wherein generating the data store includes providing the data store table with columns having the column names specified in the schema configuration, and includes populating that data store with data for the attributes from the data records that correspond to the metadata fields associated with the column names stored in the schema configuration.

17. The method according to claim 14, further determining changes to the data in the data records, and updating the metadata library with additions and deletions of metadata fields based on determined changes to the data in the data records.

18. The method according to claim 17, further comprising:
through operation of at least one processor, causing the graphical user interface to enable the user to update the schema configuration based on the changes to the metadata fields in the metadata library, and
through operation of at least one processor, updating the data store based on changes to the schema configuration and the metadata library.

19. The method according to claim 18, through operation of an application executing in at least one processor, generating a further graphical user interface that outputs indicia based on the data stored in the data store, and dynamically changing the output of the indicia based on changes to the schema configuration and metadata library.

20. A non-transitory computer readable medium encoded with executable instructions that when executed, cause at least one processor to carry out a method comprising:
through operation of at least one processor, determining metadata from data records and storing the metadata in a metadata library,
through operation of at least one processor, creating a schema configuration based at least in part on metadata accessed from the metadata library, and
through operation of at least one processor, generating a data store organized based on the created schema configuration and storing data retrieved from the data records in the data store, based at least in part on metadata accessed from the metadata library based on the schema configuration.
